(19) United States
(12) Patent Application Publication
(10) Pub. No.: US 2009/0313764 A1
(43) Pub. Date: Dec. 24, 2009

(54) FOAMS FORMULATED WITH RUBBER COMPOSITION BASED SPRINGS

(75) Inventor: Erik Deporte, Dendermonde (BE)

Correspondence Address: DARBY & DARBY P.C., P.O. BOX 770, Church Street Station, New York, NY, 10008-0770, US

(73) Assignee: Latexco NV, Tielt (BE)

(21) Appl. No.: 12/305,515

(22) PCT Filed: Jun. 22, 2007
(86) PCT No.: PCT/EP2007/005519

§ 371 Date: Mar. 4, 2009

(30) Foreign Application Priority Data
Jun. 26, 2006 (EP) 06013086.1

(51) Int. Cl. A47C 27/06; F16F 1/36; F16F 3/08; C08L 47/00; C08L 67/00; C08L 75/04

(52) U.S. Cl. 5/716; 267/153; 521/140; 521/139; 521/138; 521/137

(57) ABSTRACT

The present invention relates to springs made from compositions comprising rubber, foam formulated therewith and resulting bedding products such as foam mattress or toppers as well as other cushioning elements in a bedding or a seating product.

### TECHNICAL FIELD

The present invention relates to springs made from compositions comprising thermoset rubber material, foams formulated therewith and resulting bedding products such as foam mattress or toppers as well as other cushioning elements in a bedding or a seating product.

### BACKGROUND OF THE INVENTION

As a mattress for bedding such as a bed, there has been employed a spring assembly of a type in which a number of metal coil springs, metal torsion bars or the like are uniformly distributed.

Examples are spring mattresses which are tied together to form a mat. A round helical crosswire connects each single spring to a spring un it. Different thickness (gauge) of wire in the springs makes a harder or softer mattress. The lower the gauge, the less firm the mattress is. The number of springs per mattress type is one of the key characteristics of a spring mattress. Pocket spring mattresses contain pre-stressed springs inserted into individual fleece or cotton pockets and then clipped among one another or glued on top, middle or bottom. It is the point-by-point elasticity that distinguishes itself from others. The greater number of springs allows more flexibility so that the mattress can better mould to the body shape. This type of mattress is generally considered as the best that spring units can offer and is normally the most expensive type of product. It is higher priced because manufacturing is more complex.

Such a spring mattress, however, can be generally disadvantageous in that creak and rust occur in service thereof; and the spring assembly can be poor in matching with a fiber material such as a wrapping texture. In addition, the springs are easily felt through the top and offer little to no support.

To cope with these drawbacks, the applicant made extensive studies to develop, as an alternative of the conventional metal and plastic springs, a new concept bridging on the one hand mattresses based on foams and on the other hand spring containing mattresses i.e. mattresses incorporating springs made of thermoset rubber material, preferably natural rubber material (NR).

As the sprints according to the present invention is a spring manufactured from compositions comprising thermoset rubber, preferably natural rubber and as the latex in general is an environmentally friendly biodegradable natural product, the resulting latex mattress containing the springs of the present invention is and remains ‘all latex.’ and hence, environment friendly mattress.

In addition, the absence of metal parts avoids creating interference with the natural electromagnetic flows within the body.

In addition, the mattresses in accordance of the present invention do not require extensive costs during the recycling process since the springs do not need to be separated out as is the case for other spring containing mattresses.

In addition, the present invention has the merits of reducing the weight of the foam mattress and enhancing the ventilation properties of the foam itself.

The thermoset rubber spring can be formed into a shape quite different from that of the conventional metal spring by making use of a moulding process generally adopted for forming rubber products. With such a geometrical effect, the thermoset rubber spring is capable to ensure excellent spring characteristics matching the characteristics of the foam such as latex foams.

The thermoset rubber based spring according to the present invention meets the characteristic that when the spring is elastically deformed caused by an excessive compressive load applied thereto, the supporting state of the spring is stable and also allows large elastic deformation per unit size of the spring.

With respect to spring incorporation for a mattress using a number of single thermoset rubber composition based springs of the present invention, new structure having merits in terms of material, manufacturing, application and design technique thereof are now possible to obtain. An example is the flexibility of the mattress on supporting structures such as slat-base.

Preferred springs according to the present invention withstand compression and provide minimum energy absorption preferably with a reduced quantity of materials so as to substantially reduce the material cost of the spring.

More additional benefits associated with the springs according to the present invention are benefits such as a long useful life, or in other words excellent fatigue properties. In addition, the springs according to the present invention do not require large cross-section in order to provide the necessary spring properties. Moreover, the present springs have high stability so there is no need to be either inserted in a supporting structure or be fixed to a rigid stiffening structure.

According to another embodiment of the present invention, there is provided a spring formed from compositions comprising a thermoset rubber material, preferably natural based rubber into one body, including a plurality of members, preferably annular, arranged in such a manner as to be coaxial with each other and spaced in parallel to each other; and linkage members for linking the members to each other at a plurality of points, each of the linkage members being arranged along a virtual cylindrical face formed by the members and said linkage members formed into a predetermined pattern such as sinusoidal shape.

Other variable parameters of the spring that can be varied are the size of the members such as the radii in case of annular members, the shape of the members, the total length and size of the diameter and difference of the size of adjacent ones of the members within a single spring, the pattern of the linking members, composition of the members and/or linking members.

With this configuration and set of parameters, various springs can be made which allow a large elastic deformation per unit size because of prevention of contact between one-end portions and the other end portions of the linkage members upon deformation. The springs obtained exhibit other merits of varying the weight of springs; increasing an elastic force per unit weight of a thermoset natural based rubber material used for the spring; eliminating occurrence of creak and rust as compared to metal springs. The spring having the above merits is expected to be extensively used not only for a mattress but also for cushioning elements including pillows.

Also due to its configuration, the spring of the present invention is capable of ensuring a large allowable elastic deformation while preventing contact or interference between the linkage members and each of the members, and eliminating occurrence of noise.

In a spring assembly, according to the present invention, the springs being similar or different in configuration can be made such that these are joined to each other, each of the springs including locking means or members, for locking the springs to each other and/or to the supporting system. With this configuration, the spring assembly is allowed to ensure a stable supporting state because a load is suitably, flatly distributed by means of the springs and the springs located at positions to which the load is applied are independently elastically deformed depending on pressures applied thereto; and also the spring assembly is allowed to constitute a mattress good in structural stability.

A wide variety of spring and seat cushion assemblies incorporating different spring designs are known in the art. Many proposals have been made over the years to simplify seat and related cushion design using alternatives to conventional coil springs. For example, the following issued U.S. patents disclose such spring and cushion designs: U.S. Pat. No. 359,070, U.S. Pat. No. 1,266,359, U.S. Pat. No. 1,579,074, U.S. Pat. No. 1,814,789, U.S. Pat. No. 1,839,656, U.S. Pat. No. 2,202,630, U.S. Pat. No. 2,277,853, U.S. Pat. No. 2,321,790; U.S. Pat. No. 2,856,988, U.S. Pat. No. 3,167,353, U.S. Pat. No. 3,618,144, U.S. Pat. No. 3,869,739, U.S. Pat. No. 4,059,306, U.S. Pat. No. 4,060,280, U.S. Pat. No. 4,079,994, U.S. Pat. No. 4,109,959, U.S. Pat. No. 4,147,336; U.S. Pat. No. 4,171,125; U.S. Pat. No. 4,174,420; U.S. Pat. No. 4,254,177, U.S. Pat. No. 4,294,489, U.S. Pat. No. 4,429,427, U.S. Pat. No. 4,502,731; WO2005020761; EP 1285607, EP 1330172; JP2000175777, EP 0853901; EP0853901; EP0223617, WO2004086915, U.S. Pat. No. 6,948,205.

None of these cited documents disclose or suggest the use of springs made from compositions comprising thermoset rubber material in foams and the benefits associated therewith. These and other aspects of the invention are described in more detail by the detailed description and the Figures.

### SUMMARY OF THE INVENTION

The present invention is directed to a spring for use in foams, preferably latex foams, characterized in that the spring is made from compositions comprising thermoset rubber material.

The present invention is also directed to foams formulated therewith and resulting bedding products such as foam mattress or toppers as well as other cushioning elements in a bedding or a seating product.

### DETAILED DESCRIPTION OF THE INVENTION

According to one embodiment, the present invention is directed to a spring characterized in that the spring is made from compositions comprising thermoset, preferably natural based rubber material. In a preferred embodiment, the spring comprises: a plurality of members, preferably annular, arranged coaxially and spaced from each other in an axial direction; and a plurality of linkage members having a predetermined pattern, the linkage members being disposed and linked between two adjacent members and said linkage members being connected to each other, preferably by the peaks of the pattern (FIGS. 1, 2,3 4, 5 and 6)

Preferred patterns of the linkage members include curved lines, sinusoidal curves, straight lines, holes, spirals or combinations thereof in one single linking member or combinations thereof in each of the linking members present in the spring.

Preferably, the spring has linkage members connected to each other by the peaks of their pattern for example in case a sinusoidal pattern is chosen, the linkage members can be connected at four ends of the sinusoidal shape. Highly preferred, the spring has annular members with equal radii. Highly preferred configurations are those where the spring has at least 6 linkage members present (FIG. 1.)

According to another preferred embodiment, a spring assembly is provided comprising: a plurality of springs, an upper and a lower foam each having locking members provided on or in their surfaces for respectively locking one annular member of each spring to hold the spring between the upper and lower foam. Preferred locking members are glues.

According to another embodiment of the present invention a foam is formulated with a spring of the present invention whereby said foam is selected from latex, viscolatex, polyolefin, polyurethane, polystyrene or polyester or mixtures thereof.

According to a further embodiment; a method for producing a mattress is provided, for use as a bed, the mattress being made of substantially resilient material and thermoset, preferably natural rubber based springs being fitted in the mattress, in order to distribute the pressure exerted upon the mattress, characterized in that the mattress is constructed of at least two layers placed one on top of the other, blind holes being made in at least one of the layers, and the spring being provided in the blind holes, after which the blind holes are covered by the second layer of the mattress.

Preferred second layer of the mattress is a topper, preferably from latex.

In yet another embodiment, a mattress, for use as a bed is provided, which mattress comprises substantially resilient material, springs being provided in the mattress, in order to distribute the pressure exerted upon the mattress, wherein that the mattress comprises at least two layers placed one on top of the other, blind holes for the accommodation of the springs being made in at least one of said two layers, which blind holes connect to the boundary face between the two layers, characterized in that the springs are made from thermoset, preferably natural based rubber material.

The resilient material of the mattress suitable according to the present invention can be a foam selected from latex, viscolatex, polyolefin, polyurethane, polystyrene or polyester or mixtures thereof. The foam can be a viscoelastic foam. The foam offers a firm yet resilient support.

The foam can comprise any natural or synthetic foam, both slab and molded. The foams are open cell although application of the springs of the present invention may be formulated with closed cell foam as well. The foam may also comprise recycled foam, foam impregnated fiber mats or micro-cellular elastomer foam. Additionally, the foam may include organic and/or inorganic fillers. Furthermore, additional additives may be incorporated into the foam composition, such as, but not limited to, flame retardants, anti-fogging agents, ultraviolet absorbers, thermal stabilizers, pigments, colorants, odor control agents, perfumes and the like.

Preferred foams formulated with the springs of the present invention are latex foam and polyurethane foam.

The latex foam material can be prepared from natural rubber latex or from one or more of such synthetic latexes as polybutadiene/styrene latex, polybutadiene/acrylonitrile latex polychloroprene latex and the like or from a mixture of natural rubber latex and one or more such synthetic latexes.

Polyurethane foams with varying density and hardness may be formed. Tensile strength, tear strength, compression set, air permeability, fatigue resistance, support factor, and cell size distribution may also be varied, as can many other properties. Specific foam characteristics depend upon the selection of the starting materials, the foaming process and conditions, and sometimes on the subsequent processing.

Preferred foams according to the present invention contain additional perforations. Preferably said perforations are formed in the mattress in a pattern of rows of perforations and/or columns of perforations the spacing between two adjacent rows of perforations and/or columns of perforations.

Preferred foams according to the present invention contain profiles. According to yet another embodiment of the present invention, there is provided a foam including a convoluted top or convoluted second layer, which enhances user comfort.

The foam may also comprise further layers in addition to the top layer and second layer. Such a layer may be the bottom layer made of latex foam.

Alternatively, different layers may be added which are alternating layers existing of latex foam and foam selected from polyolefin, polyurethane, polystyrene or polyester or mixtures thereof. In these different layers, springs are inserted. The springs may be inserted such that different springs are inserted in different layers thereby forming a foam block of multiple layers having multiple spring configurations throughout the foam block.

Springs made from compositions comprising thermoset rubber.

The present invention relates generally to springs made from compositions comprising thermoset, preferably natural rubber and, more particularly, to such springs for use in a mattress comprised of a combination of such springs.

Metal and plastic spring cushion assemblies are well known within the furniture industry for use as so-called innerspring constructions for mattresses as well as other forms of upholstered furniture. Characteristically, such cushion assemblies comprise a plurality of resiliently compressible spring coils arranged in adjacent side-by-side disposition in a selected systematic array, most commonly in linear rows and columns, and connected together, e.g., by metal bands, clips, strings, helical wires, or the like, to form an integrated spring cushion assembly. Such spring cushion assemblies used for mattresses also commonly include border wires, which may be continuous or discontinuous, forming a perimeter outwardly about and connected to the upper and lower end turns of the outermost spring coils.

The thermoset, preferably natural rubber based spring according to the present invention is formed of a body for absorbing energy in all directions.

The configurations and constructions of the rubber composition based spring according to the present invention follow a predetermined shape and can be quite diverse and may differ, for example, according to the size (gauge) of the spring, whether the upper and lower end turns of each spring coil are closed or open, the number of intervening coil turns between the opposite end turns (which may be a whole number of turns or may include a one-half coil turn), and whether the spring coils are separate units or part of continuous spring unit.

In producing any given spring configuration, the selection among these various characteristics for the spring coils is made according to considerations of the desired spring characteristics for the cushion assembly (e.g., spring compressibility, strength, etc.), cost, structural stability and rigidity of the cushion assembly, etc. For example, open-ended spring coils, constructed with a full number of coil turns exhibit a pronounced tendency to incline laterally and to rotate in the direction of their hand when compressed.

Configurations include coil springs i.e. the spring is in the form of a spiral and exhibits resilient characteristic when distorted from its original shape. The form may be a helix, a volute spiral or flat spiral.

The thermoset, preferably natural rubber composition based spring include helical coil spring configuration i.e. in the form of a serial lying on the surface of a virtual cylinder and which exhibits resilient characteristics when distorted from its original shape.

In accordance with the present invention, the spring configurations and designs may be a plate or bar or a plurality of superposed plates or bars and which exhibits resilient characteristics when a portion is deflected transversely of length of the element.

Preferred configurations of the springs of the present invention are annual members laminatingly disposed in parallel at an interval of space, with respective connecting members being in a sinusoidal shape, the connecting members comprising a plurality of peaks, the connecting members oriented such along the wall of a virtual cylinder as to contact one another at the peaks of the connecting members.

The springs according to the present invention are characterized in that the springs are made from compositions comprising thermoset rubber material, preferably natural rubber material (NR).

The material compositions comprise synthetic or natural rubber material or combination thereof.

The natural rubber composition used to produce the springs according to the present invention contains a variety of ingredients such as other rubber bases, resins, fillers like carbon black, talc, clay, calcium carbonate, silica, process oils, processing aids, activators, crosslinking agents, antioxidants, pigments, foaming agents, foaming aids, and any other necessary components. If desired, a variety of short fibers may be incorporated in the rubber composition.

Synthetic rubbers comprise nitrile rubber, hydrogenated nitrile rubber, styrene-butadiene rubber, polybutadiene rubber, isoprene rubber, ethylene-propylene rubber, chlorinated polyethylene, chlorosulfonated polyethylene, ethylene vinylacetate copolymer, chloroprene rubber, butyl rubber, halobutyl rubber, epoxidized or polymethylenemethacrylate-grafted natural rubber, silicone rubber, fluorrubber or polyurethane rubber or copolymers comprising acrylates or acryl. Preferred compositions comprise combinations of natural rubber and synthetic rubber and most preferred compositions comprise no additional non NR rubber base or resin.

If combined, preferred proportions of natural rubber to other rubber base and resins can be varied. The proportions should be optimized according to the rubber used.

Illustrative rubber bases include styrene-butadiene rubber, ethylene-propylene rubber, acrylonitrile-butadiene rubber, chlorinated ethylenepropylene rubber, chlorinated polyethylene, chlorosulfonated polyethylene, silicone rubber, and fluorinated rubber. Illustrative resins include polyethylene, polypropylene, an ethylenevinyl acetate copolymer, and polyvinyl chloride. In addition to the configuration parameters, the combinations of other rubber base and resins with natural rubber based material allow to provide springs having progressively varying spring coefficients.

Illustrative processing aids include agents that serve to improve the dispersibility of fillers during mastication, tackifiers and extrusion aids. Illustrative activators include a variety of metal oxides such as zinc white and zinc stearate, glycols, and amines.

Illustrative crosslinking aids that assist the vulcanization include peroxides, a variety of sulfur and sulfur compounds, oximes, maleimides, and methacrylic acid esters.

Other Illustrative examples of the vulcanization promoting agents include: sulfenamides such as TBBS N-tert-butyl-2-benzothiazolylsulfenamide (BBS), N-cyclohexyl-2-benzothiazolylsulfenamide (CBS), and N-oxydiethylene-2-benzothiazolylsulfenamide (OBS); dithiocarbamates such as ZBEC zinc dimethyldithiocarbamate (ZnMD C), and zinc diethyldithiocarbamate (ZnEDC); and thiurams such as tetramethyl thiuram disulfide (TMTD), tetraethyl thiuram disulfide (TETD), and tetrabutyl thiuram disulfide (TBTD) and dithiophosphates such as zinc dialkyldithiophosphates and mercaptobenzothiazol (MBT) or mercaptobenzothiazylsulfide (MBTS) and guanidines such as diphenylguanidine (DPG) or DOTG. Typical vulcanization promoting aids include zinc oxide and stearic acid.

Various other suitable additives used for rubber material compositions may be added to the unvulcanized rubber, as needed. Those additives may include: reinforcing agents such as carbon black; products of reaction between acetone and diphenylamine; phenylenediamines such as N-phenyl-N′-isopropyl-p-phenylenediamine; anti-aging agents such as wax, hindered phenol compounds and benzimidazol compounds; and softening agents such as process oil and mineral oil. Needless to say, these additives should not prevent the spring from exhibiting the desired property of low dynamic spring stiffness, and the amounts of the additives should be determined so as not to deteriorate this property.

The types and amounts of these ingredients and the crosslinking agent are properly selected and determined in accordance with the specific properties required for the final rubber product.

The rubber composition used in the present invention may be prepared by blending appropriate ingredients with rubber by means of a suitable machine such as a Banbury mixer, a kneader, or a mixing mill, and is subsequently shaped by means of a calendar, an extruder or a stripping line.

Typically, to mix the vulcanizing agent and the various additives indicated above with the rubber material composition, the vulcanizing agent and the additives are added to the rubber, and these components are evenly kneaded or mixed together by a suitable kneader or mixer, for instance by a mixing mill, so that the unvulcanized rubber material can be uniformly vulcanized in a desired manner, in a vulcanizing step following the addition of the vulcanizing agent and additives. The kneading or mixing length of time and the temperature condition in which the kneading is effect are suitably selected.

After the vulcanizing agent and additives are added to the rubber material, the obtained rubber composition is formed into the desired spring with the unvulcanized rubber material being vulcanized, as indicated above. To this end, the rubber composition is formed into a desired shape, by a suitable molding method using a mold, for instance, at the suitably determined temperature at which the unvulcanized rubber material is vulcanized. It is preferable to form the spring by a press-molding, using a compression, a transfer or an injection method, and vulcanizing process in which the molding and the vulcanization are effected concurrently. The vulcanizing conditions such as the temperature, pressure and time may be determined as needed, depending upon the specific kinds of the rubber material, vulcanizing agent and additives, so as to vulcanize the rubber as desired.

An alternative production method may be the extrusion and subsequent curing of a continuous profile, followed by cutting the desired spring by means of suitable methods such as knife, laser or water jet.

By employing the process of the present invention, springs having the properties as described hereinbefore can be obtained.

In case other rubber base or resin is added, it may be desirable to prepare a mixture of the unvulcanized rubber, vulcanizing agent and additive or additives, with a suitable proportion, in the form of a master batch, for example. In this case, the prepared mixture and the rubber are introduced into the kneader, so as to establish the desired ratio by weight of the NR rubber and other rubber base material. This method is effective to shorten the time required for kneading or mixing the materials within the kneader, and permit improved uniformity or evenness of dispersion of the other rubber base, vulcanizing agent and additive(s) in the NR rubber.

The materials which have been introduced into the kneader as described above are subsequently kneaded so that the other rubber base can be is divided into fine particles small enough to provide the desired characteristics of the produced spring of the present invention.

Preferred dimensions of mentioned springs according to the present invention are hollow products cylindrical, or multi-angled, with typical wall thickness between 3 and 10 mm. The typical length of the individual springs is preferably between 60 and 200 mm. The typical diameter is between 30 and 100 mm. The cut section of the springs is preferably cylindrical or multi-angled, preferably between 4 (quadrangle) and 8 (octagon) angles.

The wall of the hollow springs can be designed in various patterns, such as holes, spirals, curves. Preferably, the curves have dimensions with cut sections of diameter or thickness between 3 and 10 mm.

The springs comprised in this invention have typical spring constants between 0.05 N/mm and 0.5 N/mm. The material composition and the design of the mentioned springs can be adjusted to become the desired spring properties, one of the features being a progressively spring constant.

According to the invention it has been found that by using the spring in accordance with the present invention, a stable spring is obtained so that the springs can be fixed for example simply by gluing them to the outer layers without necessarily requiring a stiffening structure. In addition, it has been found that it is moreover possible to compress the springs to a large extent whilst providing still the same spring properties. These spring properties are determined by the so-called spring constant or spring coefficient expressed for example in N/cm. By providing more than one coil, the individual coils are less loaded so that the wire diameter thereof may be smaller and so that better fatigue properties can be expected.

As described hereinabove, the spring does not necessarily have to be made of compositions comprising rubber material only. As mentioned already hereinabove, it is for example also possible to reinforce the rubber material by providing fibres therein, for example glass, carbon, aramid or steel fibres. The coils may also be formed of layers of different material, for example of a polymeric outer layer and a polymeric inner or core layer as disclosed in EP-A-0 328 014. Additionally, the spring may include organic and/or inorganic fillers. Furthermore, additional additives may be incorporated into the spring material composition, such as, but not limited to, flame retardants, anti-fogging agents, ultraviolet absorbers, thermal stabilizers, pigments, colorants, odor control agents, perfumes and the like.

From the above, it is clear that, in accordance with the present invention, springs with varying density and hardness may be formed. Tensile strength, tear strength, compression set, air permeability, fatigue resistance, support factor may also be varied, as can many other properties. Specific spring characteristics depend upon the selection of the starting materials, the configuration, the moulding process and conditions, and sometimes on the subsequent processing.

The springs in accordance with the present invention inherently provide a greater independent support characteristic relative to other springs such as plastic springs.

It is believed that this difference is attributable to the compositional differences between the materials and is reflected, at least in part, in the typical load deflection curves for each type of material. A load-deflection curve is typically a graph of the force in lbs. required to indent a flat disk of 50 sq. in. (8″ diameter) into the material being tested for any given percentage of deflection. Springs can be designed such that, either in their own or in combinations with other springs, the springs match the load deflection properties and characteristics of the latex. Latex is typically characterized by having a more gradual slope in the lower portion of the curve, that is in the range of 5-10% deflection, which typically becomes steeper in the higher portion of the curve, that in the range of 50-70% of deflection. Plastic springs, on the other hand, typically have a steeper initial portion of the curve, in the range of 5-10% deflection, which typically decreases in the higher deflection ranges.

Thus, while the rubber spring of the present invention has a softer initial feel, it resists deflection at heavier loads resulting in a greater independent support. Accordingly, it is desirable that the springs according to the present invention have a load deflection curve which has a more gradual slope in the 5-10% deflection range.

It is possible according to the invention for spring devices to be distributed over the mattress, the spring characteristic of the springs varying along the length of the mattress. When the mattress is in use, a person will exert pressures of different magnitudes upon different points of the mattress. For instance, more pressure will be exerted upon the mattress at the level of the hips than at the level of the feet. According to the present invention, it is possible to adapt the spring characteristic of the springs used in such a way that optimum pressure distribution is experienced along the longitudinal direction of the mattress. It is possible in this case for the mattress to comprise a head end specifically intended for that purpose and a foot end specifically intended for that purpose.

Preferably the springs are placed in zones near those parts of a user's body that secrete the most sweat, mainly the neck, the back and the thighs.

The advantage of this is that the body moisture can be discharge directly via the springs, which is achieved in part as a result of the changes in the user's position, which produced also movements of air through the perforations, thus effecting a natural ventilation of the upper mattress. The perforations thus prevent moisture remaining accumulated within the mattress too long, which might lead to fungoid growth and further unpleasant effects.

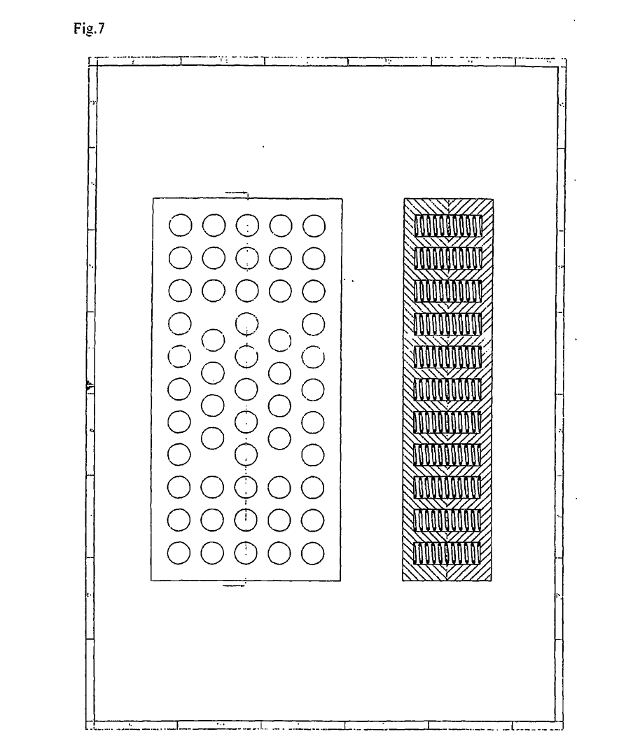

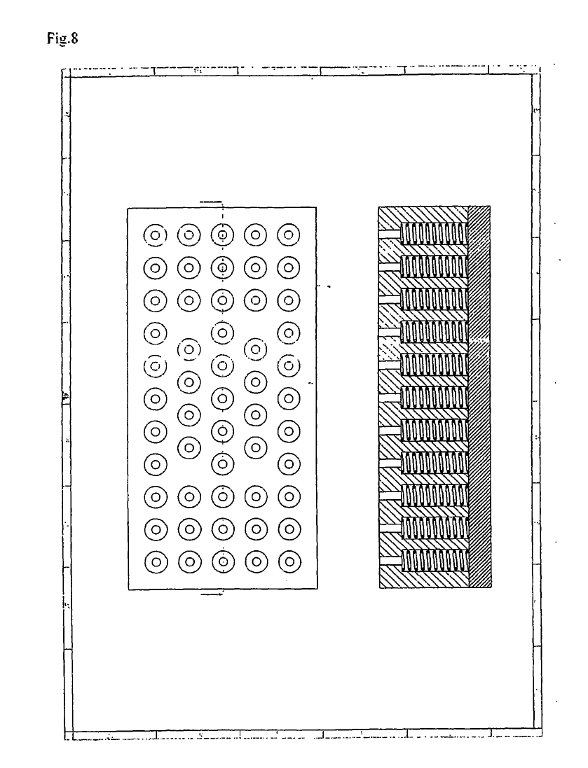

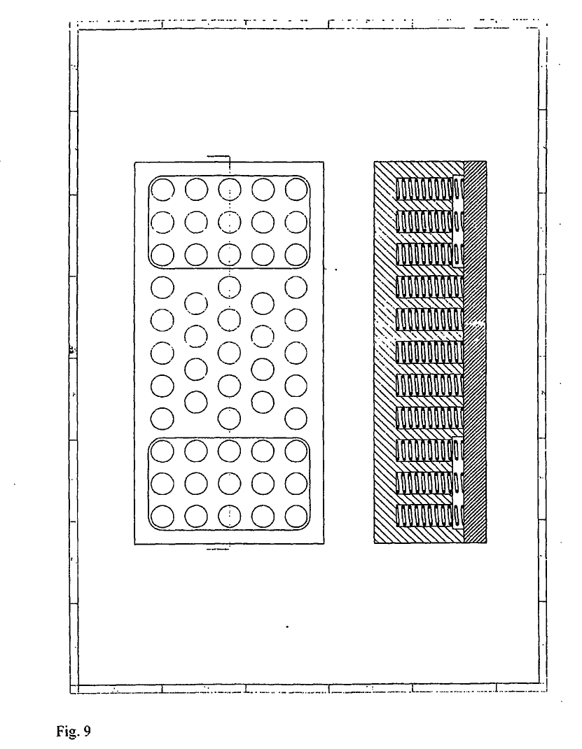

The present invention further relates to a method for producing a mattress, for use as a bed, the mattress being made of substantially resilient material such as foam rubber, and spring devices such as coil springs being fitted in the mattress, for the distribution of pressure exerted upon the mattress (FIGS. 7, 8 and 9)

A preferred method according to the present invention is characterized in that the mattress is constructed of at least two layers placed one on top of the other, blind holes being made in at least one of the layers, and spring elements being provided in the blind holes, after which the blind holes are covered by the second layer of the mattress. The method according to the present invention can be such that blind holes are provided in both a first and a second layer of the mattress, and spring devices are subsequently provided in the blind holes of the first layer of the mattress, the spring devices then being covered by the second layer of the mattress, so that the blind holes of the first layer of the mattress lie in line with the blind holes of the second layer of the mattress.

If there is a desire to provide the mattress with a genuine bottom side and a genuine top side, it is possible to make the bottom side of a relatively cheap material. The comfort requirements to be made of this material will be less than the requirements to be made of the top side.

According to another embodiment of the invention, the top side is made as a topper for a conventional mattress, which rests upon a conventional bed. Toppers for use in bedding or seating products are known. These toppers extend across the entire width and length of the particular bedding or seating product. If the particular bedding or seating product is a mattress, typically one such topper is placed on one side of the mattress core, and a second topper is placed on the opposite side of the mattress core, thereby effectively “sandwiching” the mattress core. This combination then typically is covered with an upholstered fabric covering.

The foam formulated with the springs of the present invention can be used in numerous other applications. Main sectors of application are automotive and aircraft industry, upholstered furniture and technical articles. For instance, full foam seats, top pads for the seats and restraints for back and head, all made from the beddings of the present invention can be used in cars and aeroplanes. Other applications include the use of foamed seat saddles for motorbikes, gaskets between a car body and its lights, lip seals of air filters for engines and insulating layer on car parts and engine parts to reduce sound and vibration. It will be appreciated that each specific application puts its own demands on the springs to be used. Important characteristics in this connection are density, hardness, resilience of the rubber based springs and in order to fit each application, these characteristics should be optimally balanced and adjusted.

Other suitable applications of the novel rubber based springs in accordance with the invention are those where energy absorption management is required. In this case, the present invention has broad, varied foam applications that may include use in automobiles, vibration isolation for engine and for vehicle platforms, and energy absorption in athletic shoes.

In another embodiment of the present inventions customizing springs for its use as bedding can be done by a potential user by the analysis of that user's “sleep profile and comfort”. The sleep-comfort profile assesses such factors as the user's general health anti sleep habits. A firmness recommendation is computer either in terms of a pressure for various zones of a “test mattress” containing an air bladder or in terms of a foam type and density for each zone. In addition, a surface recommendation is established based on the user's responses to a surface recommendation enquiry and the springs of the present invention are then tailored according to the consumer needs.

The body supporting resilient element according to the invention may have different shapes and compositions and is in particular a mattress, cushion, a base of a bed or a sofa, a seating or back rest of any seat or any other upholstered furniture. In FIGS. 7, 8 and 9, a mattress according to the invention is schematically illustrated. The mattress comprises two outer layers, more particularly a top and a bottom layer which may be made of a natural or synthetic foam material such as latex or polyurethane foam. In the layers a number of rubber compositions based springs are inserted.

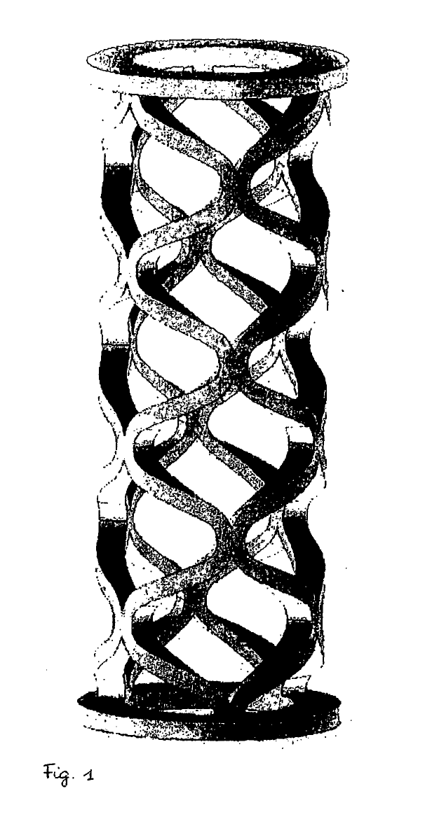

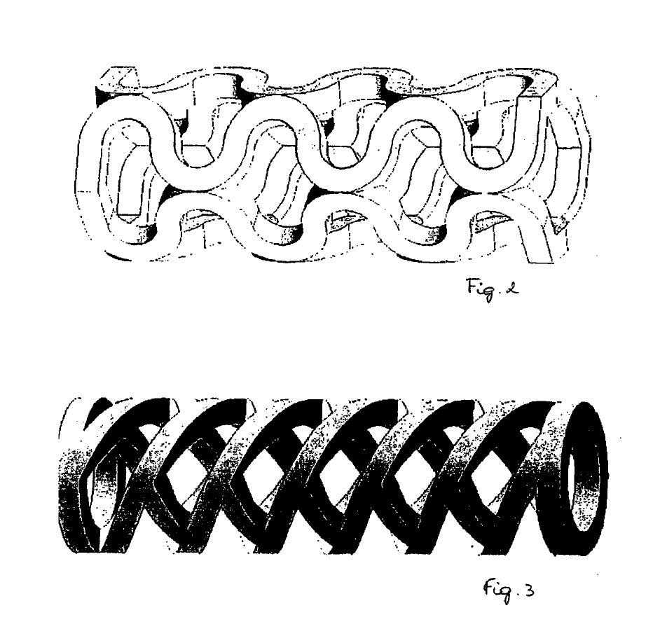

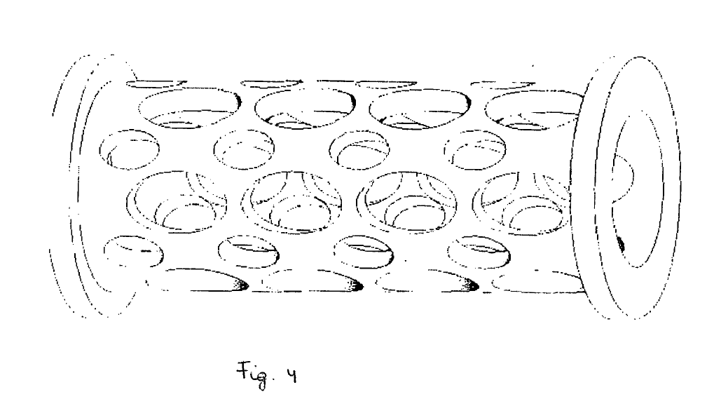

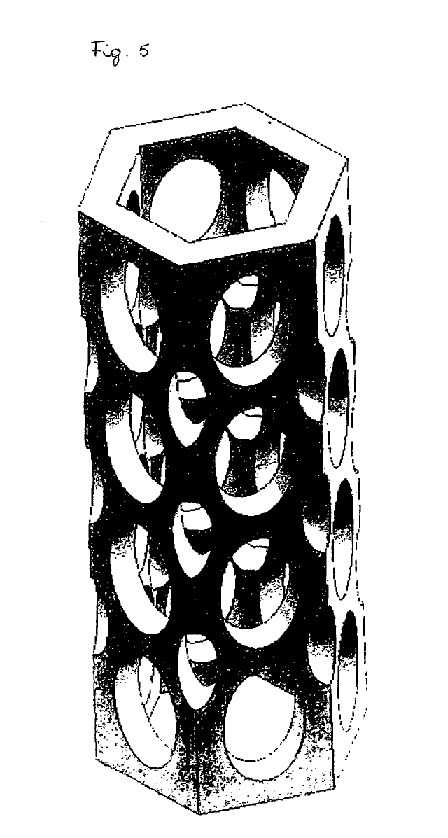

The thermoset rubber based springs shown in FIGS. 1 to 5 may also simply be glued either directly to the top and bottom layers or through the intermediary of intermediate layers, for example textile layers to which the springs can for example be fixed by sewing. On the other hand, also more rigid intermediate layers can be used wherein recesses can be provided wherein the extremities of the springs fit or to which the springs can be fixed by means of threads. Preferably the mattress may also be formed partially or entirely by a foam matrix wherein holes are provided wherein the springs can be inserted. It will be clear that many other different mattress constructions may be possible and that the shape or composition of the mattress or other body supporting element is not limiting at all for the scope of protection. In case of a bed or seat base, the top and or bottom layers may for example be formed by a textile layer.

1. A spring for use in foams, wherein the spring is made from compositions comprising thermoset rubber material.

2. A spring according to claim 1 further wherein said rubber material is natural rubber material.

3. A spring according to claim 1 comprising i) a plurality of members arranged coaxially and spaced from each other in an axial direction ii) a plurality of linkage members having a predetermined pattern, the linkage members being disposed and linked between two adjacent members and said linkage members being connected to each other.

4. A spring according to claim 1, wherein the members under i) are annular and have different or equal radii.

5. A foam formulated with a spring as defined in claim 1 whereby said foam is selected from latex, viscolatex, polyolefin, polyurethane, polystyrene or polyester or mixtures thereof.

6. A spring assembly comprising i) a plurality of springs as defined in claim 1, ii) an upper and/or a lower foam each having locking members provided on or in their surfaces for respectively locking one member of each spring to hold the spring.

7. A method for producing a mattress, for use as a bedding or seating product, the mattress being made of substantially resilient material and rubber composition based springs being fitted in the mattress, in order to distribute the pressure exerted upon the mattress, further wherein the mattress is constructed of at least two layers of foam placed one on top of the other, blind holes being made in at least one of the layers, and the spring being provided in the blind holes, after which the blind holes are covered by the second layer of the mattress.

8. Method according to claim 7, wherein blind holes are provided in the second layer of the mattress, and rubber composition based springs are subsequently provided in the blind holes of the second layer of the mattress, the spring devices then being covered by the first layer of the mattress being a topper.

9. A mattress comprising substantially resilient material, springs being provided in the mattress, in order to distribute the pressure exerted upon the mattress, wherein that the mattress comprises at least two layers placed one on top of the other, blind holes for the accommodation of the springs being made in at least one of said two layers, which blind holes connect to the boundary face between the two layers, wherein the springs are made from compositions comprising rubber.

10. A mattress according to claim 9, wherein blind holes are provided in the second layer of the mattress, and natural rubber based springs are subsequently provided in the blind holes of the second layer of the mattress, the spring devices then being covered by the first layer of the mattress being a topper.
